(19) United States
(12) Patent Application Publication
(10) Pub. No.: US 2006/0005129 A1
(43) Pub. Date: Jan. 5, 2006

(54) Method and apparatus for inputting ideographic characters into handheld devices

(75) Inventors: Yandong Wen, Beijing (CN); Meng Lu, Beijing (CN); Gekai Zou, Beijing (CN); Donglai Luo, Beijing (CN); Yanqing Cui, Beijing (CN); Zhe Nan, Beijing (CN); Yong Gou, Beijing (CN); Wenjing Guo, Beijing (CN)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/141,806

(22) Filed: May 31, 2005

(30) Foreign Application Priority Data
May 31, 2004 (CN) 200410046214.9

(51) Int. Cl. G06F 15/00; G06F 17/27; G09G 5/00; G06F 17/00

(52) U.S. Cl. 715/536; 345/171; 704/9; 715/816

(57) ABSTRACT

The present invention provides a method of inputting ideographic characters into a handheld device, comprising steps of: predicting ideographic characters that correspond to symbols inputted by a user, for said user to select; predicting, based on a previous ideographic character that has been selected by said user, ideographic characters that most likely follow said previous ideographic character but cannot form a phrase with said previous ideographic character, for said user to select; and inputting ideographic characters that have been selected by said user into said handheld device. The present invention also provides an apparatus for inputting ideographic characters and a handheld device. According to the invention, more ideographic characters and punctuation marks are automatically predicted, which speeds up the process of inputting ideographic characters into handheld devices.

### FIELD OF THE INVENTION

The present invention relates to handheld devices, and in particular to a method and apparatus for inputting ideographic characters into handheld devices.

### BACKGROUND OF THE INVENTION

Ideographic characters are commonly used for Asian languages, such as Chinese and Japanese. Developers of handheld devices have struggled with designing method and apparatus for inputting ideographic characters into handheld devices.

A conventional device for inputting data into handheld devices is a keypad typically having only 12 to 24 keys of which 10 keys are used for entering numbers 1 through 9 and 0. The keypad is typically used on telephones, mobile phones and similar handheld devices. Scrollers, rotators, or wheels may also be used to input ideographic characters into handheld devices. Handwriting recognition technology may also be implemented in handheld devices for inputting ideographic characters.

In order to input ideographic characters into a handheld device via a keypad, the phonetic letters (e.g., pinyin or zhuyin letters for Chinese characters) or the strokes of the ideographic characters are first mapped by the manufacturer of the handheld device onto the 10 keys of the keypad, which are used for entering numbers. Then, for inputting an ideographic character into the handheld device via the keypad, a user may, in one input mode, enter the phonetic letters of the ideographic character by pressing the numeric keys of the keypad, and select one of the ideographic characters to be predicted and displayed by the handheld device based on the entered phonetic letters. Alternatively the user may, in another input mode, enter the strokes of the ideographic character by pressing the numeric keys of the keypad, and select one of the ideographic characters to be predicted and displayed by the handheld device based on the entered strokes. Hereinafter, the phonetic letters and strokes of ideographic characters are simply called symbols.

In order to speed up the process of inputting ideographic characters into handheld devices, inputting methods with phrase prediction capability have been developed. That is, after an ideographic character has been inputted, the handheld device predicts and displays several ideographic characters each of which may form a phrase with the ideographic character that has been previously inputted. In so doing, the user may simply select the predicted and displayed ideographic characters to finish the whole phrase, rather than to individually input the characters included in the phrase.

Take Chinese for example. [symbol] (today) is a Chinese phrase. After [symbol] has been inputted, [symbol] (day) may be automatically predicted and displayed by the handheld device. Thus, the user may simply select [symbol] to finish the input of [symbol] (today). [symbol] (eat a meal) is another Chinese phrase. After [symbol] (eat) has been inputted, [symbol] (a meal) may be automatically predicted and displayed by the handheld device. Thus, the user may simply select [symbol] to finish the input of [symbol] (eat a meal).

Only after the first character of a phrase has been inputted can the prior methods of inputting ideographic characters with phrase prediction capability work. However, sentences of ideographic languages are composed of not only phrases but also auxiliary characters. For example, in the Chinese sentence [symbol] [symbol] (Have you eaten a meal today?), [symbol] (today) and [symbol] (eat a meal) are phrases, while other characters are not.

Apparently, the prior methods of inputting ideographic characters with phrase prediction capability is useful only for inputting less than half of characters in a sentence.

Besides, if phrases can be inputted directly via the inputting method, the phrase prediction capability is almost useless.

Also, it is burdensome to input a punctuation mark. Users usually have to select one punctuation mark from a plurality of punctuation marks.

Therefore, there is a need in the art to develop a method and apparatus by which ideographic characters and punctuation marks can be quickly inputted into handheld devices.

### SUMMARY OF THE INVENTION

Embodiments of the present invention provide convenient methods and apparatuses for inputting ideographic characters and punctuation marks into handheld devices.

One embodiment of the invention provides a method of inputting ideographic characters into a handheld device, the method comprising:
predicting ideographic characters that correspond to symbols inputted by a user, for said user to select;
predicting, based on a previous ideographic character that has been selected by said user, ideographic characters that most likely follow said previous ideographic character but cannot form a phrase with said previous ideographic character, for said user to select; and
inputting ideographic characters that have been selected by said user into said handheld device.

An other embodiment of the invention can be an apparatus for inputting ideographic characters into a handheld device, the apparatus comprising:
means for predicting ideographic characters that correspond to symbols inputted by a user, for said user to select;
means for predicting, based on a previous ideographic character that has been selected by said user, ideographic characters that most likely follow said previous ideographic character but cannot form a phrase with said previous ideographic character, for said user to select; and
means for inputting ideographic characters that have been selected by said user into said handheld device.

Still another embodiment of the invention can be a handheld device, comprising:
a transition prediction database, for storing a plurality of ideographic character sequences, each of said plurality of ideographic character sequences comprising a previous ideographic character and at least one ideographic character that most likely follows said previous ideographic character but cannot form a phrase with said previous ideographic character; and
a controller, for referring to said transition prediction database for ideographic character sequences whose said previous ideographic character is identical to an ideographic character that has been inputted by a user.

According to embodiments of the present invention, phrases can be automatically predicted. Ideographic characters that most likely follow the previous character but cannot form a phrase with the previous character can also be automatically predicted. Additionally, punctuation marks can be automatically predicted. All of these can greatly increase the speed of inputting ideographic characters and punctuation marks into handheld devices.

Other features and advantages of the present invention should be apparent from the following description of various embodiments, taken in conjunction with the accompanying drawings, which illustrate, by way of example, the principles of the invention.

### BRIEF DESCRIPTION OF THE DRAWINGS

FIG. 1 is the flowchart of one method of inputting ideographic characters into a handheld device according to one embodiment of the present invention;

FIG. 2 schematically shows the structure of one possible handheld device according to the present invention, which includes an apparatus for inputting ideographic characters according to one embodiment of the present invention;

FIG. 3 illustrates one sample process of inputting a Chinese sentence using various embodiments of the present invention.

### DESCRIPTION OF THE PREFERRED EMBODIMENT

The embodiments of the present invention will be described in detail.

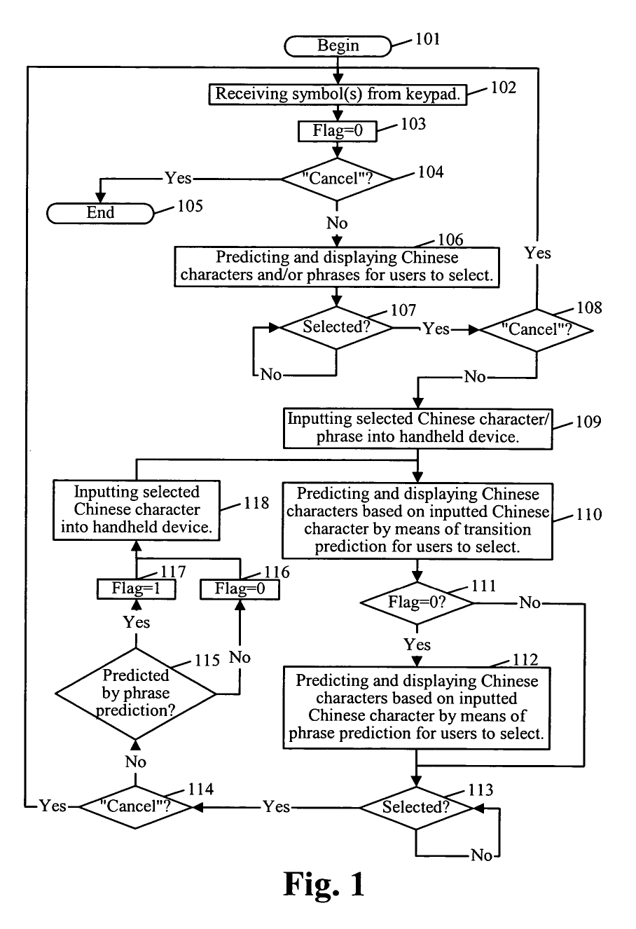

FIG. 1 is the flowchart of one sample method of inputting ideographic characters into a handheld device according to one embodiment of the present invention.

At step 101, the process begins.

At step 102, symbols can be received from an inputting device of a handheld device. The handheld device for example can be a mobile phone, a PDA, etc. The inputting device for example can be a keypad or a scroller mounted on a handheld device, or any other equivalent devices for inputting symbols into a handheld device.

At step 103, a flag can be set to zero. The flag can be used to decide whether to initiate phrase prediction capability. (See steps 111 and 112). In one embodiment this flag is optional, and phrase prediction capability (step 112) may be valid all the time. If phrase prediction capability is only initiated under certain conditions, inputting ideographic characters into handheld devices may be sped up.

At step 104, it can be determined whether “Cancel” has been pressed. If the result of step 104 is “Yes”, the process can go to step 105 where the process ends. If the result of step 104 is “No”, the process can go to step 106.

At step 106, ideographic characters (such as Chinese characters) and/or phrases can be predicted based on the symbols received at step 102, and the predicted ideographic characters and/or phrases can be displayed for the user to select. Various conventional process of predicting ideographic characters and/or phrases based on symbols inputted by a user can be used.

At step 107, it can be determined whether a selection has been made by the user. If the result of step 107 is “No”, the process can wait at step 107. If the result of step 107 is “Yes”, the process can go on to step 108.

At step 108, can be determined whether “Cancel” has been pressed. If the result of step 108 is “Yes”, the process can go back to step 102. If the result of step 108 is “No”, the process can go on to step 109.

At step 109, the ideographic characters and/or phrases that have been selected by the user at step 107 can be inputted into the handheld device. Then process can go on to step 110.

At step 110, ideographic characters (such as Chinese characters) can be predicted by means of transition prediction, based on the characters that have been inputted into the handheld device at step 109 (i.e., the characters that have been selected by the user at step 107), and the predicted ideographic characters can be displayed for the user to select. Transition prediction is described in detail as follows.

Transition prediction can be used to predict ideographic characters and punctuation marks based on at least one ideographic character (called “previous character” here) . Based on the previous character, ideographic characters that most likely follow the previous character but cannot form a phrase with the previous character can be predicted. Also, punctuation marks that most likely follow the previous character can be predicted.

For example, if the previous character is [symbol] the characters that may be predicted by transition prediction may include [symbol] etc. The character sequences [symbol] are not phrases in Chinese language, but they frequently appear in sentences.

If the previous character is [symbol] the punctuation marks that may be predicted by transition prediction may include question mark “?”. In Chinese, [symbol] generally appears at the end of a question.

At step 111, it can be determined whether the flag is zero. If the result of step 111 is “No”, the process can go on to step 113. If the result of step 111 is “Yes”, the process can go on to step 112.

At step 112, ideographic characters (such as Chinese characters) can be predicted by means of phrase prediction, based on the characters that have been inputted into the handheld device at step 109 (i.e., the characters that have been selected by the user at step 107), and the predicted ideographic characters can be displayed for the user to select.

Conventional phrase prediction technology can be used to predict ideographic characters based on at least one ideographic character (called “previous character” here). Based on the previous character, ideographic characters that may form a phrase with the previous character can be predicted.

For example, if the previous character is [symbol] the characters that may be predicted by phrase prediction may include [symbol] etc. [symbol] are phrases in Chinese language.

The order of steps 110 and 112 are not important and constitutes no restriction to the present invention. That is, steps 111 and 112 may be performed ahead of step 110.

At step 113, it can be determined whether a selection has been made by the user. If the result of step 113 is “No”, the process can wait at step 113. If the result of step 113 is “Yes”, the process can go on to step 114.

At step 114, it can be determined whether “Cancel” has been pressed. If the result of step 114 is “Yes”, the process can go on back to step 102. If the result of step 114 is “No”, the process can go on to step 115.

At step 115, it can be determined whether the ideographic character that has been selected by the user at step 113 is predicted by phrase prediction (i.e., at step 112). If the result of step 115 is “No”, the process can go on to step 116. If the result of step 115 is “Yes”, the process can go on to step 117.

At step 116, the flag can be set to zero. At step 117, the flag can be set to one.

At step 118, the ideographic characters that have been selected by the user at step 113 can be inputted into the handheld device. Then the process can go back to step 110.

Of course, if a punctuation mark has been selected by the user at step 113, the selected punctuation mark can be inputted into the handheld device at step 118, and the process can go back to step 102.

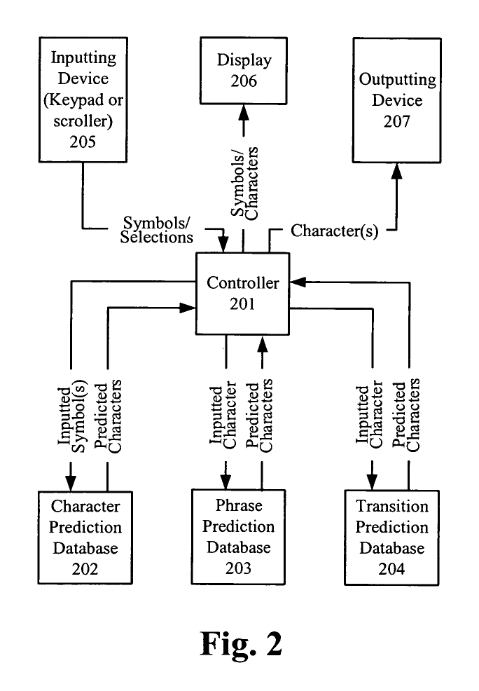

FIG. 2 schematically shows the structure of one embodiment of a handheld device according to the present invention, which can include apparatus for inputting ideographic characters according to one embodiment of the present invention. While a handheld device is discussed herein, the concepts and principles of the invention can be applied and used in non-handheld devices as well.

In FIG. 2, reference numeral 201 denotes a controller, 202 character prediction database, 203 phrase prediction database, 204 transition prediction database, 205 inputting device such as a keypad or a scroller, 206 display, and 207 outputting device.

Controller 201 can initially receive symbols, inputted by the user, from inputting device 205. Inputting device 205 for example can be a keypad, a scroller, or any other equivalent devices for inputting symbols into a handheld device.

Controller 201 can then refer to character prediction database 202 for ideographic characters that match the symbols received from inputting device 205, and can display the matched ideographic characters on display 206 for the user to select.

If the user selects one of the plurality of ideographic characters displayed on display 206, controller 201 can receive the selection (for example, a digit associated with the selected ideographic character) from inputting device 205, and operate outputting device 207 to output the selected ideographic character to the component of the handheld device for which the method of inputting ideographic characters has been initiated. For instance, such a component may be a short message composer, a notepad, a telephone directory, a dictionary, etc.

In one embodiment, character prediction database 202 car store symbol strings and corresponding characters in a table. A conventional character prediction database 202 and conventional operations of predicting characters based on symbols can be used.

If controller 201 receives a selection from inputting device 205, controller 201 can refer to phrase prediction database 203 for ideographic characters each of which may form a phrase with the ideographic character selected by the user, and display the predicted ideographic characters on display 206 for the user to select.

In one embodiment, phrase prediction database 203 can store a plurality of phrases in a table. Phrase prediction database 203 and operations of predicting phrases based on initial characters can be used.

Preferably, controller 201 controls phrase prediction database 203 in such a way that phrase prediction database 203 works only after the user selects an ideographic character that has been predicted by character prediction database 202 or by transition prediction database 204. That is to say, if the user selects an ideographic character that has been predicted by phrase prediction database 203, controller 201 does not refer to phrase prediction database 203 again for ideographic characters.

Take Chinese phrase [symbol] (today) for example. If the user selects [symbol] phrase prediction database 203 predicts [symbol] and other Chinese characters. If the user further selects [symbol] to finish inputting the phrase [symbol] controller 201 does not refer to phrase prediction database 203 until the user selects an ideographic characters which is either predicted by character prediction database 202 or by transition prediction database 204.

If controller 201 receives a selection from inputting device 205, controller 201 can also refer to transition prediction database 204 for ideographic characters that most likely follow the previous character but cannot form a phrase with the previous character, and for punctuation marks that most likely follow the previous character, and display the predicted ideographic characters and punctuation marks on display 206 for the user to select.

In one embodiment, transition prediction database 204 can store in a table a plurality of character sequences and character-punctuation mark combinations that are frequently used in sentences. Each character sequence can be composed of a previous character and at least one character that most likely follows the previous character but cannot form a phrase with the previous character. Each character-punctuation mark combination can be composed of a previous character and at least one punctuation mark that most likely follows the previous character.

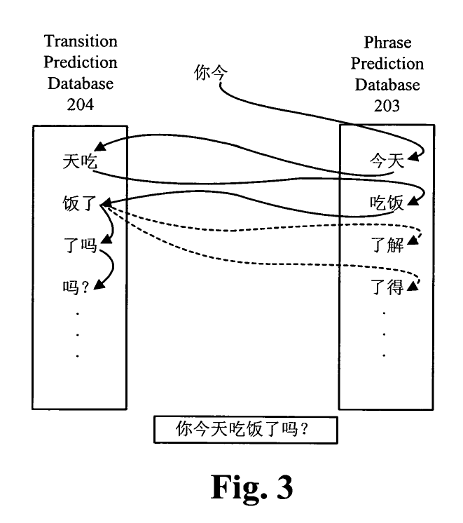

FIG. 3 depicts a process of inputting a Chinese sentence using the method and apparatus according to the present invention.

In FIG. 3, suppose character sequences that are frequently used in Chinese sentences include [symbol] [symbol] etc. and phrases include [symbol] [symbol] etc. The above character sequences can be stored in transition prediction database 204, and the above phrases can be stored in phrase prediction database 203.

In order to input a sentence [symbol] [symbol] the user initially inputs symbols (for example, pinyin or zhuyin symbols) for [symbol] and symbols for

[symbol]

Then [symbol] and other possible characters can be predicted by controller 201 by referring to phrase prediction database 203, and displayed on display 206. The user may simply select [symbol] from display 206 via inputting device 205.

After [symbol] is selected, [symbol] and other possible characters can be predicted by controller 201 by referring to transition prediction database 204, and displayed on display 206. The user may simply select [symbol] from display 206 via inputting device 205.

After [symbol] is selected, [symbol] and other possible characters are predicted by controller 201 by referring to phrase prediction database 203, and are displayed on display 206. The user may simply select [symbol] from display 206 via inputting device 205.

After [symbol] is selected, [symbol] and other possible characters can be predicted by controller 201 by referring to transition prediction database 204, and displayed on display 206. The user may simply select [symbol] from display 206 via inputting device 205.

After [symbol] is selected, [symbol] and other possible characters are predicted by controller 201 by referring to transition prediction database 204, and are displayed on display 206. [symbol] and other possible characters can be predicted by controller 201 by referring to phrase prediction database 203, and displayed on display 206. [symbol] are Chinese phrases.) The user may simply select [symbol] rather than [symbol] and [symbol] from display 206 via inputting device 205.

After [symbol] is selected, “?” and other possible punctuation marks or ideographic characters can be predicted by controller 201 by referring to transition prediction database 204, and displayed on display 206. The user may simply select “?” from display 206 via inputting device 205.

Thus, the whole sentence [symbol] [symbol] can be inputted into the handheld device.

Apparently from the above example, if there were no transition prediction database 204, the user would have to input symbols for [symbol] and input question mark “?”. The function of transition prediction database 204 can be used to assist the user in inputting symbols for [symbol] and inputting question mark “?”. This can greatly speed up the process of inputting the sentence

[symbol]

While the foregoing has been with reference to specific embodiments of the invention, it will be appreciated by those skilled in the art that these are illustrations only and that changes in these embodiments can be made without departing from the principles of the invention, the scope of which is defined by the appended claims.

What is claimed is:

1. A method of inputting ideographic characters into a device, the method comprising:
predicting ideographic characters that correspond to symbols inputted by a user, for said user to select;
predicting, based on a previous ideographic character that has been selected by said user, ideographic characters that most likely follow said previous ideographic character but cannot form a phrase with said previous ideographic character, for said user to select; and
inputting ideographic characters that have been selected by said user into said device.

2. The method of claim 1, further comprising:
predicting, based on a previous ideographic character that has been selected by said user, punctuation marks that most likely follow said previous ideographic character, for said user to select.

3. The method of claim 1, further comprising:
predicting, based on a previous ideographic character that has been selected by said user, ideographic characters each of which may form a phrase with said previous ideographic character, for said user to select.

4. The method of claim 2, further comprising:
predicting, based on a previous ideographic character that has been selected by said user, ideographic characters each of which may form a phrase with said previous ideographic character, for said user to select.

5. An apparatus for inputting ideographic characters into a device, the apparatus comprising:
means for predicting ideographic characters that correspond to symbols inputted by a user, for said user to select;
means for predicting, based on a previous ideographic character that has been selected by said user, ideographic characters that most likely follow said previous ideographic character but cannot form a phrase with said previous ideographic character, for said user to select; and
means for inputting ideographic characters that have been selected by said user into said device.

6. The apparatus of claim 5, further comprising:
means for predicting, based on a previous ideographic character that has been selected by said user, punctuation marks that most likely follow said previous ideographic character, for said user to select.

7. The apparatus of claim 5, further comprising:
means for predicting, based on a previous ideographic character that has been selected by said user, ideographic characters each of which may form a phrase with said previous ideographic character, for said user to select.

8. The apparatus of claim 6, further comprising:
means for predicting, based on a previous ideographic character that has been selected by said user, ideographic characters each of which may form a phrase with said previous ideographic character, for said user to select.

9. A handheld device, comprising:
a transition prediction database, for storing a plurality of ideographic character sequences, each of said plurality of ideographic character sequences comprising a previous ideographic character and at least one ideographic character that most likely follows said previous ideographic character but cannot form a phrase with said previous ideographic character; and
a controller, for referring to said transition prediction database for ideographic character sequences whose said previous ideographic character is identical to an ideographic character that has been inputted by a user.

10. The handheld device according to claim 9, wherein said transition prediction database is further configured for storing a plurality of character-punctuation mark combinations, each of said plurality of character-punctuation mark combinations comprising said ideographic previous character and a punctuation mark that most likely follows said previous ideographic character, and
wherein said controller is configured for referring to said transition prediction database for character-punctuation mark combinations whose said previous ideographic character is identical to said ideographic character that has been inputted by said user.

11. The handheld device according to claim 9, further comprises a phrase prediction database, configured for storing a plurality of phrases; and
wherein said controller is also configured for referring to said phrase prediction database for phrases which include said ideographic character that has been inputted by said user.

12. The handheld device according to claim 10, further comprises a phrase prediction database, configured for storing a plurality of phrases; and
wherein said controller is also configured for referring to said phrase prediction database for phrases which include said ideographic character that has been inputted by said user.

13. A method of inputting ideographic characters into a device, the method comprising:
predicting ideographic characters that correspond to symbols inputted by a user, for said user to select;
predicting, based on a previous ideographic character that has been selected by said user, punctuation marks that most likely follow said previous ideographic character, for said user to select; and
inputting punctuation marks that have been selected by said user into said device.

14. A computer program product for inputting ideographic characters into a device, the computer program product comprising a computer-readable storage medium having computer-readable program code embodied in the medium, the computer-readable program code comprising:
computer-readable program code that predicts ideographic characters that correspond to symbols inputted by a user, for said user to select;
computer-readable program code that predicts, based on a previous ideographic character that has been selected by said user, ideographic characters that most likely follow said previous ideographic character but cannot form a phrase with said previous ideographic character, for said user to select; and
computer-readable program code that inputs ideographic characters that have been selected by said user into said device.

15. The computer program product of claim 14, further comprising:
computer-readable program code that predicts, based on a previous ideographic character that has been selected by said user, punctuation marks that most likely follow said previous ideographic character, for said user to select.

16. The computer program product of claim 14, further comprising:
computer-readable program code that predicts, based on a previous ideographic character that has been selected by said user, ideographic characters each of which may form a phrase with said previous ideographic character, for said user to select.

17. The computer program product of claim 15, further comprising:
computer-readable program code that predicts, based on a previous ideographic character that has been selected by said user, ideographic characters each of which may form a phrase with said previous ideographic character, for said user to select.
